(19) United States
(12) Patent Application Publication
(10) Pub. No.: US 2025/0023713 A1
(43) Pub. Date: Jan. 16, 2025

(54) SYSTEMS AND METHODS FOR LOCALIZED PRIVATE KEY RETRIEVAL

(71) Applicant: Capital One Services, LLC, McLean, VA (US)

(72) Inventors: Kevin OSBORN, Newton Highlands, MA (US); Andrea MONTEALEGRE, Arlington, VA (US); Asher SMITH-ROSE, Midlothian, VA (US)

(21) Appl. No.: 18/222,318

(22) Filed: Jul. 14, 2023

(51) Int. Cl. H04L 9/08; G06Q 20/36

(52) U.S. Cl. CPC H04L 9/0819; G06Q 20/36; H04L 9/3242; H04L 2209/56

(57) ABSTRACT

Systems and methods for the localized storage and retrieval of private keys are provided. The system includes a card, a user device, and an ATM. The method comprises validating the user's identity, encrypting the private key, and depositing the key into the ATM. Another method comprises withdrawing the private key in a paper or virtual form.

### FIELD OF DISCLOSURE

The present disclosure relates to the localized storage and retrieval of private keys associated with cryptocurrency wallets.

### BACKGROUND

Cryptocurrency wallets are the most common method of storage for cryptocurrencies. To use a wallet, one needs a private key. The private key is often a long list of characters that acts as a key for signing cryptocurrency transactions. In current markets, there are only two main options for storing a private key: a hot (or online) wallet and a cold (or offline) wallet. The private key can be stored online or on a server—this is known as a hot wallet, called so because they are vulnerable to hacking. Hot wallets are not recommended for users with a significant amount of cryptocurrency. Alternatively, a private key can be stored offline or on hardware copy—this is called a cold wallet. Offline storage can take many forms: a compact disc, a flash drive, or a piece of paper.

Though these methods avoid the risk of hacking, they are extremely prone to being lost and forgotten. A hardware wallet can be misplaced, stolen, or damaged. Consequently, the holder of a damaged wallet loses access to his wallet and the all the value associated with it. So, wallet holders are given two difficult choices: use a hot wallet with the risk of hacking; or use a cold wallet with the risk of loss or damage.

These and other deficiencies exist. Therefore, there is a need to provide a system that overcomes these deficiencies and provides for secure localized private key retrieval.

### SUMMARY

Embodiments of the present disclosure provide a system for storing and retrieving private keys associated with a cryptocurrency wallet, the system comprising: a card, a user device, and an automated teller machine (ATM). The ATM further comprises a data storage unit and a processor. The processor is configured to transmit an authentication request for a private key; receive an authentication credential associated with the private key; validate, by applying an algorithm, the authentication credential, the authentication credential associated with user identification data; and transmit the private key associated with a cryptocurrency wallet to the user.

Embodiments of the present disclosure provide a method for storing and validating private keys associated with a cryptocurrency wallet. The method comprises the steps of: providing an ATM with a data storage unit further configured to hold an encrypted private key; transmitting, by a processor, an authentication request for the private key; opening, in response to the authentication request, a communication field between a user device and a card; receiving, by a processor, an authentication credential for the private key, the authentication credential associated with user identification data; validating, by a processor, the authentication credential; and transmitting the private key from the ATM to a user.

Embodiments of the present disclosure provide non-transitory computer-readable storage medium. The computer-readable storage medium includes instructions that, when executed by a computer hardware arrangement comprising a processor, configure the processor to perform procedures comprising the steps of: transmitting an authentication request for the private key; opening, in response to the authentication request, a communication field between a user device and a card; receiving an authentication credential for the private key, the authentication credential associated with user identification data; validating the authentication credential; and transmitting the private key to a user.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a system diagram according to an exemplary embodiment.

FIG. 2 is a diagram of a contactless card according to an exemplary embodiment.

FIG. 3 is a diagram of a contactless card according to an exemplary embodiment.

FIG. 4 is a diagram illustrating a process of creating a private key and public key according to an exemplary embodiment.

FIG. 5 is a diagram illustrating the process of creating a mnemonic phrase according to exemplary embodiment.

FIG. 6 is a diagram of a cryptocurrency hierarchal deterministic wallet according to an exemplary embodiment.

FIG. 7 is a diagram of a paper wallet according to an exemplary embodiment.

FIG. 8 is a flow chart of a method of cryptography according to an exemplary embodiment.

FIG. 9 is a sequence diagram of a method for depositing an encrypted private key into ATM according to an exemplary embodiment.

FIG. 10 is a method flow chart of a process for requesting a paper wallet from an ATM according to an exemplary embodiment.

FIG. 11 is a sequence diagram illustrating a process for requesting a virtual copy of a private key from an ATM according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The embodiments provide several technological improvements for storing and retrieving private keys associated with a cryptocurrency wallet. The system includes an ATM as a part of the infrastructure for storing and retrieving private keys. This expands the options available to cryptocurrency users beyond the traditional hot and cold wallets. The system incorporates an authentication process to ensure the validity and authorization of the private key retrieval. An authentication request is transmitted, and an authentication credential associated with the private key and user identification data is required for validation. This helps prevent unauthorized access to the private keys. The private key is stored within the data storage unit of the ATM, which offers a secure and centralized location for the keys. By centralizing the storage in a secure environment, the risk of loss, damage, or theft associated with physical storage methods like hardware wallets or paper-based solutions is reduced. With the ATM-based system, users can access their private keys using their user devices. The ATM opens a communication field between the user device and a card, enabling secure transmission of the private key. This provides a convenient and efficient method for users to retrieve their private keys.

Overall, the ATM system allows seamless integration with user devices such as smartphones or tablets. By opening a communication field between the user device and a card, the private key can be securely transmitted to the user's device. This integration streamlines the retrieval process and provides a familiar and intuitive interface for users to interact with during the key retrieval process. This scalability makes the system suitable for accommodating a growing number of cryptocurrency users and their private key retrieval needs. As the popularity of cryptocurrencies increases, having a scalable solution like an ATM-based system ensures efficient and reliable access to private keys.

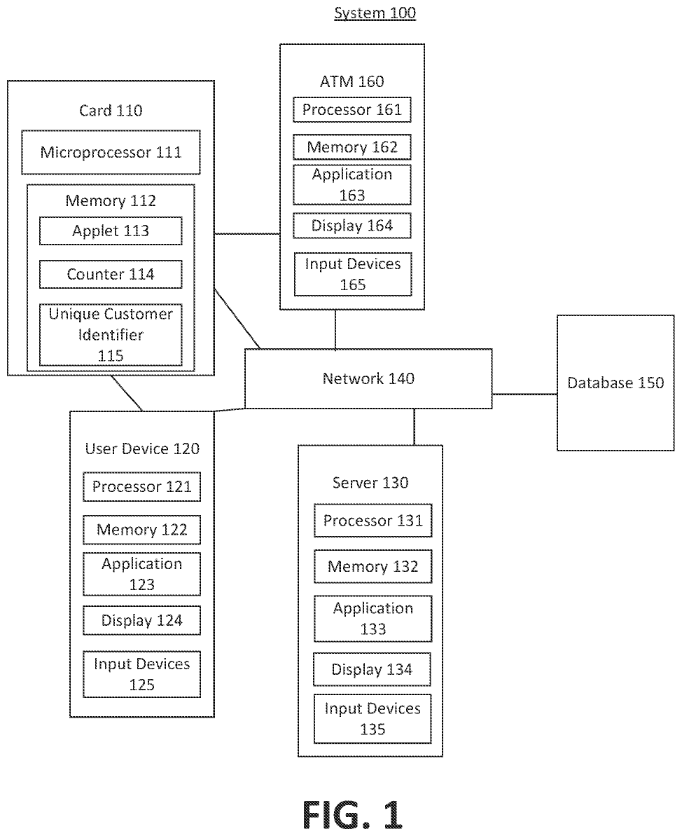

FIG. 1 is a block diagram of a system according to an exemplary embodiment.

FIG. 1 illustrates a system 100 according to an example embodiment. The system 100 may comprise a contactless card 110, a user device 120, a server 130, a network 140, a database 150, and an automated teller machine (ATM) 160. Although FIG. 1 illustrates single instances of components of system 100, system 100 may include any number of components.

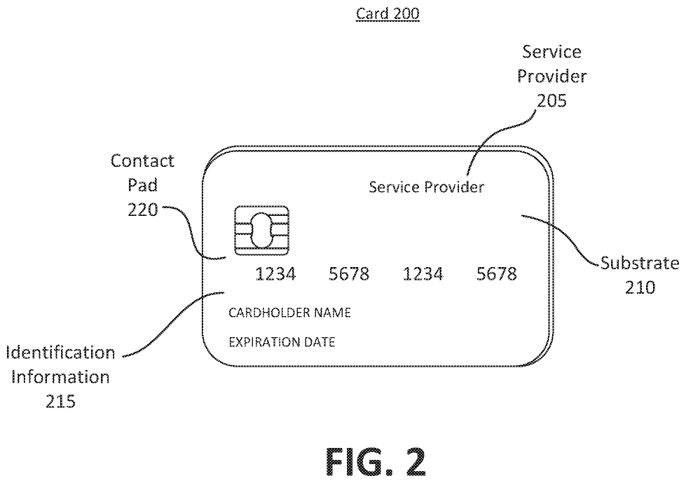

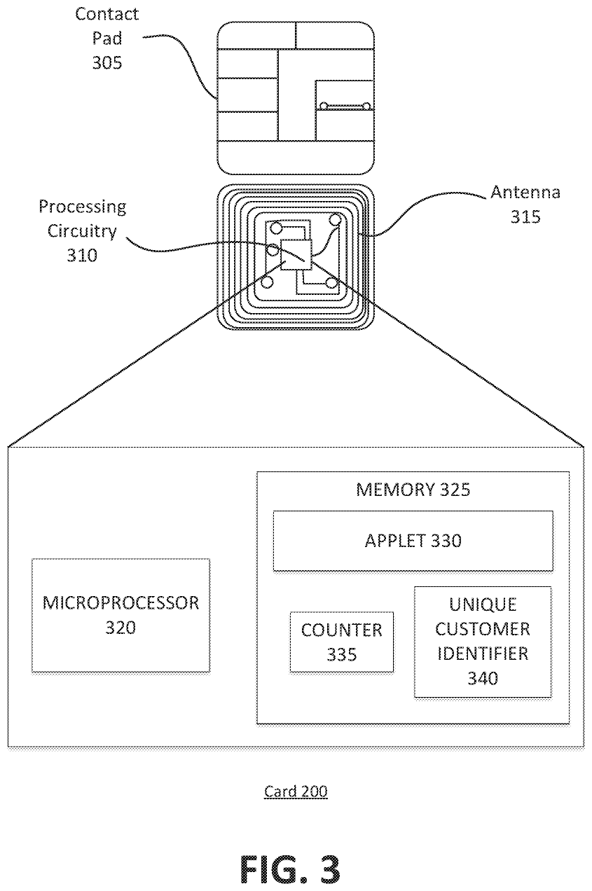

System 100 may include one or more contactless cards 110 which are further explained below with reference to FIG. 2 and FIG. 3. In some embodiments, contactless card 110 may be in wireless communication, utilizing NFC in an example, with user device 120. The contactless card may have a microprocessor 111, a memory 112, an applet 113, counter 114, and a unique customer identifier 115.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the ATM 160, retaining a web session between the user device 120 and the ATM 160, and masking private data received from the user device 120 and the ATM 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that can be available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network and may be configured to connect the user device 120, the server 130, the database 150 and the ATM160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition, or alternatively, a storage arrangement can be provided separately from the computer-accessible medium, which can provide the instructions to the processing arrangement so as to configure the processing arrangement to execute certain exemplary procedures, processes, and methods, as described herein above, for example.

The ATM 160 may include a processor 161, a memory 162, and an application 163. The processor 161 may be a processor, a microprocessor, or other processor, and the ATM 160 may include one or more of these processors. The ATM can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the ATM 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the ATM 160. In some examples, the ATM 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. For example, the application 163 may be executed to perform receiving web form data from the user device 120 and the ATM 160, retaining a web session between the user device 120 and the ATM 160, and masking private data received from the user device 120 and the ATM 160. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The ATM 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

FIG. 2 is a diagram illustrating a contactless card according to an exemplary embodiment.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card. The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2). FIG. 3 illustrates a contact pad according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

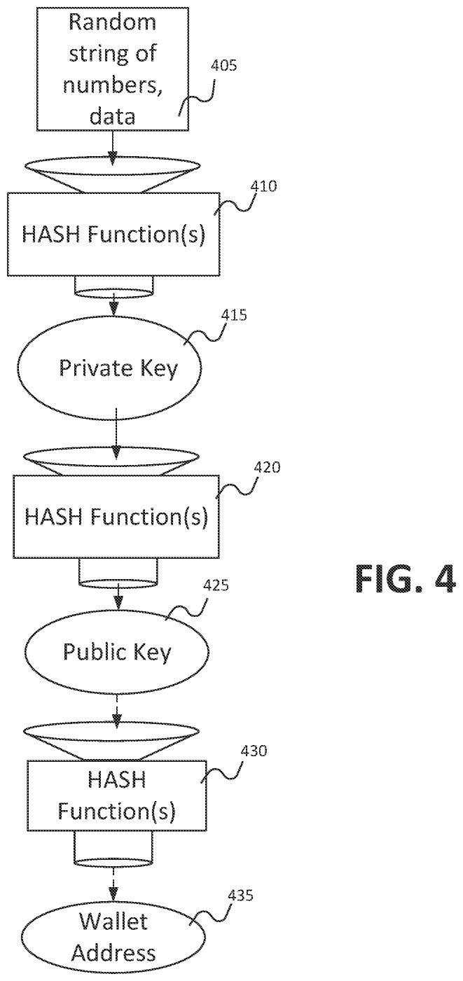

FIG. 4 is a diagram illustrating a process of creating private keys and public keys for a cryptocurrency wallet. The process is an example of how one or more private keys and public keys can be created.

In action 405, the user can create a random string of numbers, letters, characters, or other data. This data can be chosen by the user, or the user can operate a random number generator. The string of data can vary in length. This action can be done by a processor.

Next, in action 410 the random data can be operated upon by a hash function. A hash function can be any mathematical function that can be used to map a set of data into a different set of data. In some examples, a hash function can be a function that scrambles a piece of information so that the original information can be mathematically infeasible to figure out. The output of a hash function can be called a hash value, hash code, or simply a hash. Though there are many different kinds of hash functions, most hash functions convert variable-length keys into fixed-length values. For example, SHA256, a very common hash function, will always produce an output of 256 bits no matter the length of the input. Other hash functions will produce outputs of other lengths, including 32 bits, 64 bits, or 128 bits.

Most hash functions will create a unique value for every input. For example, inputting the random data set of “8;nm,desfnyt55 [9[[bdc,.aq123” through the SHA256 hash function will always produce the same output of:
01d81e1a585c9ac701e5e4cc24ddef098286ccef55167001f2ea5e41e06eaae1
   If the input is changed even slightly, the output will appear completely different. For example, if the last character of the input is changed from a 3 to a 4, the resulting output becomes:
1a48beda31b3f56b92eaa30050c0bd16c061ca366be0703d76dca46245a2dda9 Hash functions provide an added level of security to encryption and security access.

In action 415, the has function produces an output that becomes the private key. The private key can be a data set of indefinite length and of varying character use. For example, the private key may be a 256-bit string of characters ranging from 0-9 and the letters A through F. The private key can be used to access the crypto wallet.

In action 420, one or more hash functions are applied to the private key. The resulting output can be the public key 425. These hash functions used in action 420 may be the same hash functions used in action 410, or they may be different.

In some instances, the hash function in action 420 can be replaced with elliptic curve multiplication. It is not necessary to apply elliptic curve multiplication to a private key in order to make a public key. However, it offers an alternative method of scrambling the private key to make a public key. Elliptic curve multiplication is the action of multiplying the private key k by some constant G. One can call this operation (G)(k). The constant G is a pair of vertices on a two-dimensional elliptic curve. Calculating (G)(k) will produce a new value K. The new value K is another set of vertices on the same elliptic curve. Because the multiplication of vertices on an elliptic curve is unpredictable, the private key k cannot be derived easily from K. This new value resulting from (G)(k) is the public key in action 425.

In some examples, the private key and public key are all that is required to create a cryptocurrency wallet. However, in other examples, additional processing can be performed. In action 430, the public key is fed through a hash function. This hash function may or may not be the same hash function used in action 410 and in action 420.

In action 435, the hash function of action 430 produces a different set of data that is commonly referred to as the wallet address. The public key and the wallet address serve the same function of associating a cryptocurrency user with their cryptocurrency.

Regarding cryptocurrency wallets, private keys are the passwords to the wallet. Without the private key, the wallet owner cannot access any of the cryptocurrency associated with the wallet. Therefore, wallet owners often take precautions to prevent the private key from being lost. But because the private key is typically a string of seemingly random characters, wallet owners often prefer to encode their private key into a list of mnemonic words. This list of words is easier to remember.

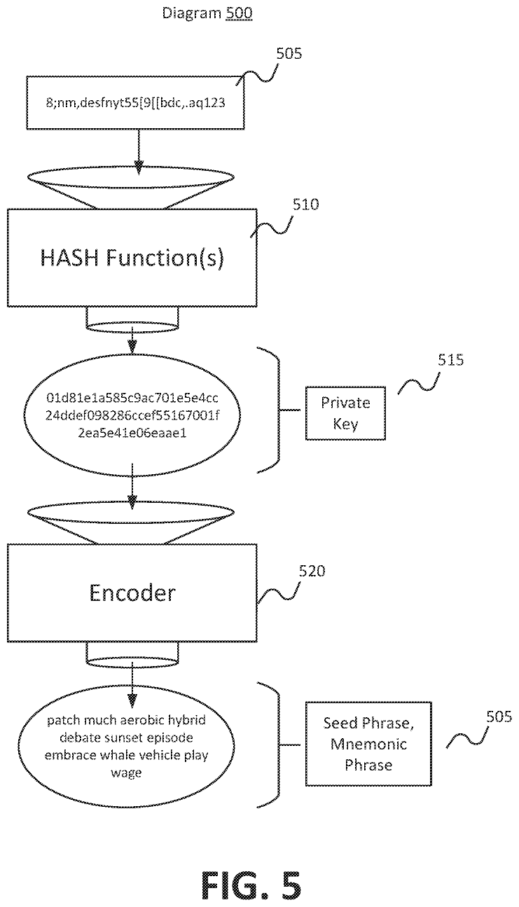

FIG. 5 describes how a private key can be converted in a mnemonic phrase.

In action 505, a random set of data is created. Then in action 510, a hash function is applied to the data set and creates the private key in action 515. Hash functions are further described with reference to FIG. 4.

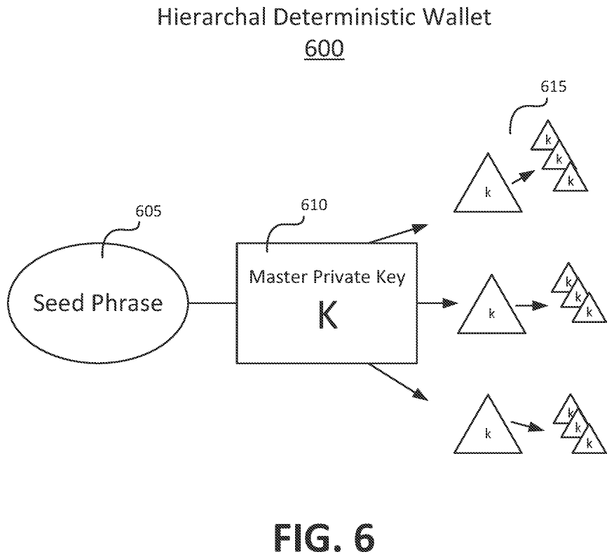

In action 520, the private key is fed through an encoder that is programmed to convert a data set into a mnemonic phrase. The encoder attaches certain values to each character in the private key. After calculating the values of each character, the encoder will match the values to a different predetermined set of words. Matching the private key values to the encoder values will produce a mnemonic phrase in action 525 that is composed of seemingly unrelated words. This is often called a seed phrase. In practice, the seed phrase would act as a wallet owner's private key. FIG. 6 is a diagram illustrating a hierarchal deterministic wallet.

In modern commercial practice, many cryptocurrency wallets will produce a different private key and public key for every cryptocurrency transaction performed by a user. Wallets with this function can be called hierarchal deterministic (HD) wallets, which can add another layer of security to cryptocurrency transactions.

In action 605, the wallet owner has a seed phrase that was created when the user first created their wallet. The seed phrase can be used to create a master private key in action 610. It is understood that often action 605 and 610 are interchangeable, where a master private key can be used to create a seed phrase.

The master private key is called the master key because all subsequent private keys are derived from it. In action 615, the hierarchal deterministic wallet creates new private keys from the master key. Then, a subsequent transaction will create another private key derived from the previous one, and so on.

In order to access all later transactions, a user only needs to have the seed phrase or master private key. Using the master private key, the user can derive every subsequent private key and therefore every transaction associated. This process of derivation is why a wallet owner will typically have a hard copy of the seed phrase or master private key.

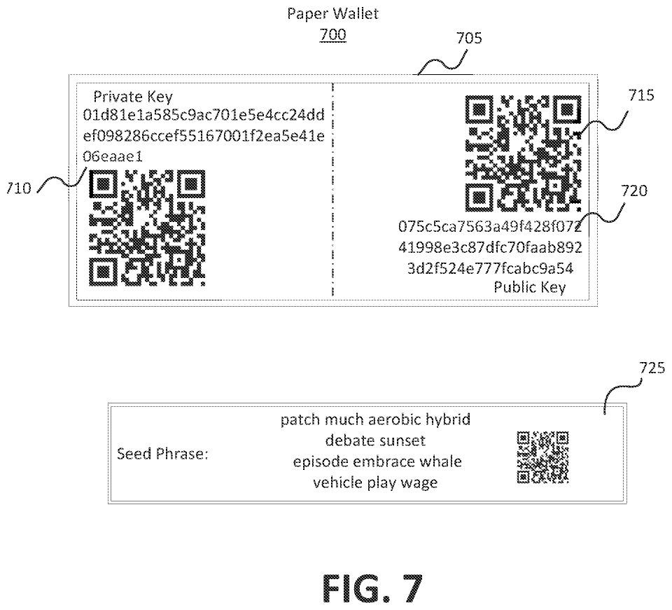

FIG. 7 is a diagram illustrating a paper wallet according to an exemplary embodiment.

A paper wallet is an example of a hot wallet or offline wallet. Instead of keeping their private key online or on a server, many cryptocurrency wallet owners prefer to keep their private key on a paper wallet. A paper wallet is a piece of paper containing the private and public key associated with a user's wallet.

The paper wallet can be composed of a body 705 that can be composed of paper, plastic, metal, or some other material suitable for printing, engraving, or scanning. On the body 705, there can be a private key 710 and a public key 720. The keys can be depicted as their alphanumeric data sets, as quick response (QR) codes 715, or as seed phrases 725. A user may use a camera-enabled device to scan the QR code and access the private key. The paper wallets may be printed by a predetermined device such as a private printer or an ATM.

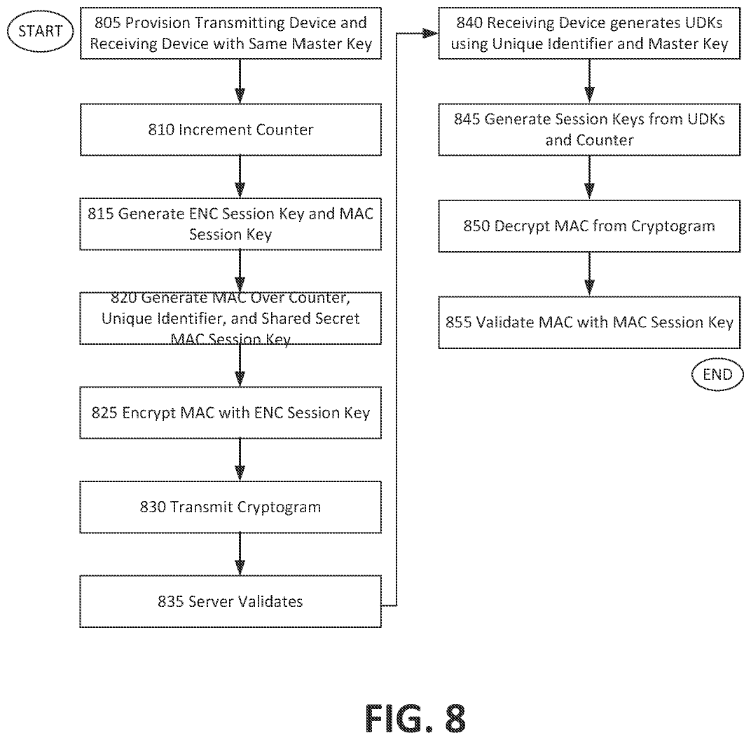

FIG. 8 is a flow chart of method 800 of key diversification according to an example of the present disclosure.

For example, a sender and recipient may desire to exchange data via a transmitting device (e.g., a user device) and a receiving device (e.g., a storage device and/or a user device). As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device. The transmitting device and the receiving device may be configured to communicate via NFC, Bluetooth, RFID, Wi-Fi, and/or the like.

The method 800 can begin with Step 805. In step 810, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the sender may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 810, the transmitting device may take the selected cryptographic algorithm, and using the master symmetric key, process the counter value 335. For example, the sender may select a symmetric encryption algorithm, and use a counter which updates with every conversation between the transmitting device and the receiving device The one or more counters 335 may comprise a numeric counter sufficient to store an integer. The processor may increment the counter one or more times.

In step 815, the transmitting device generates two session keys: one ENC (encryption) session key and one MAC (message authentication code) session key. The transmitting device may encrypt the counter value with the selected symmetric encryption algorithm using the master symmetric key to create a session key.

In step 820, the processor generates the MAC over the counter 335, the unique customer identifier 340, and the shared secret MAC session key. The customer identifier 340 may comprise a unique alphanumeric identifier assigned to a user of the contactless card, and the identifier may distinguish the user of the contactless card from other contactless card users. In some examples, the customer identifier 340 may identify both a customer and an account assigned to that customer and may further identify the contactless card associated with the customer's account.

In step 825, the processor encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 830, the processor transmits a cryptogram to the receiving device. The receiving device can the contactless card 110. The cryptogram can include the applet information 330, the unique customer identifier 340, the counter value 335, and the encrypted MAC.

In step 835, the server validates the cryptogram. The server may be a part of the transmitting device or receiving device. Alternatively, the server may be a separate entity.

In step 840, the receiving device generates its own UDKs (unique diversified keys) using the unique customer identifier 340 and the master key. The unique customer identifier is derived from the validated cryptogram. Recall that the receiving device has already been provisioned with the master key.

In step 845, the receiving device generates two session keys: one ENC (encryption) session key and one MAC (message authentication code) session key. The receiving device may generate these session keys from the UDKs and the counter value. The counter value can be derived from the cryptogram.

In step 850, the receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

In step 855, the receiving device validates the MAC with the MAC session key generated in step 815. The receiving device may validate the MAC over the unique customer identifier and the counter value.

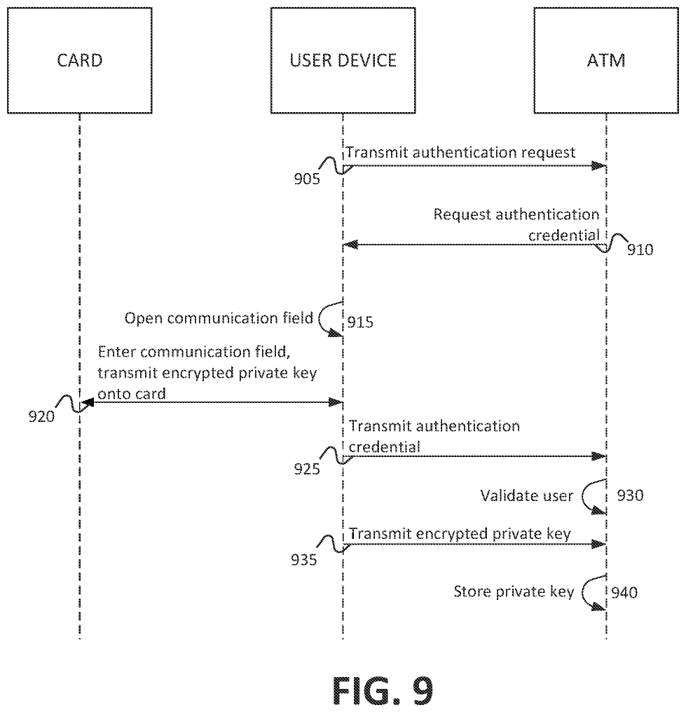

FIG. 9 is a sequence diagram illustrating a process of encrypting and depositing a private key into an ATM.

The sequence 900 includes a contactless card, a user device, and an automated teller machine (ATM). The contactless card is further explained with reference to FIGS. 2 and 3. The user device is further explained with reference to FIG. 1. The ATM can be onsite, offsite, standalone, networked, online, or offline. The ATM is described further with reference to FIG. 1.

In step 905, the user device transmits an authentication request to the ATM. This step can be performed by a processor. The processor may be a part of the user device. The request can be sent over a network.

In step 910, in response to the authentication request the ATM requests an authentication credential from the user device. This step can be performed by a processor. The processor can be a part of the ATM. The request can be sent over a network.

Next, in step 915 the user device opens a communication field. The communication field can be via NFC, Bluetooth, RFID, Wi-Fi, and/or the like. This step can be performed by a processor. The processor can be a part of the user device.

Next, in step 920 the contactless card enters the communication field. The card and the user device exchange information over the communication field. This step can be performed by a processor. The processor may be a part of the card or the user device. The information shared by the card may be shared in the card's memory or applet information.

Next, in step 925 the authentication credential is transmitted to the ATM. This step can be performed by a processor. The processor can be a part of the card or the user device. The credential can be sent over a network. The credential can be associated with user identification data. In other embodiments, the credential can be associated with a biometric transmitted from the user to the ATM. As a nonlimiting example, the user can supply a fingerprint scan, facial scan, or voice scan to the ATM.

Next, in step 930 the ATM receives the authentication credential and validates the user. This step can be performed by a processor or a predetermined algorithm. The processor may be a part of the ATM. Generally, the processor or algorithm determines whether the user identification data from the credential sufficiently matches the user identification data known to the ATM.

Next, in step 935 the user device transmits their encrypted private key to the ATM. This step can be performed by a processor. The key can be sent over a network.

Next, in step 935 the ATM receives the encrypted private key and stores it. The ATM can store the private key in a data storage unit within the ATM hardware.

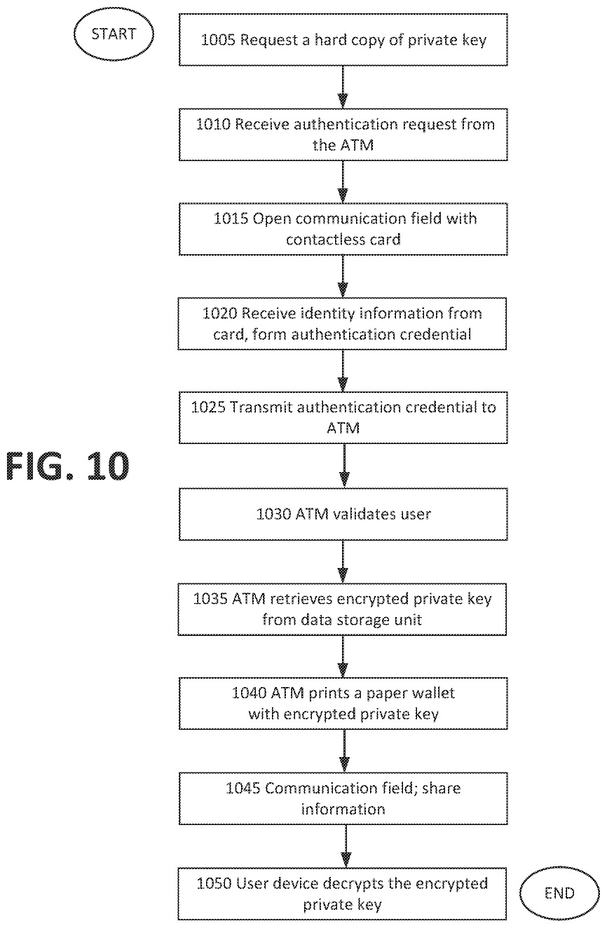

FIG. 10 is a method flow chart illustrating a process of requesting a paper wallet of an encrypted private and public key according to an example embodiment.

In step 1005, the user device requests a hard copy or paper wallet of the private key. The request can be sent by a processor over a network. The ATM may receive the request.

In step 1010, the user device receives an authentication request from the ATM. The request can be sent by a processor over a network. The processor may be part of the ATM or a separate server.

Next, in step 1015 the user device opens a communication field with the contactless card. This step may be performed by a processor. The processor may be a part of the user device or the card.

Next, in step 1020 the user device and card share information. The information may be identity information or other secure information associated with the user. The information may be the applet information stored in the card's memory. The information shared by be encrypted using diversified key exchange further described with reference to FIG. 8.

Next, in step 1025 the user device transmits the authentication credential to the ATM. This action may be performed by the processor associated with the user device. The credential can include without limitation a personal identification number (PIN), password, or card information. In other embodiments, the credential can be associated with a biometric transmitted from the user to the ATM. As a nonlimiting example, the user can supply a fingerprint scan, facial scan, or voice scan to the ATM.

Next, in step 1030 the ATM validates the user. Validation can be performed by a predetermined algorithm or processor within the ATM.

Next, in step 1035 the ATM retrieves the encrypted private key from the data storage unit within the ATM.

Next in step 1040 the ATM prints a paper wallet with the encrypted private key on it. The paper wallet may be comprised of paper, metal, plastic, or some other material suitable for printing, engraving, or scanning.

Next, in step 1045 the user device again opens a communication field and share information with the card. Once again, the user device and the card exchange secure information designed to confirm the user's identity.

Next, in step 1050 the user device decrypts the encrypted private key. The method of decryption is explained further with reference to FIG. 8.

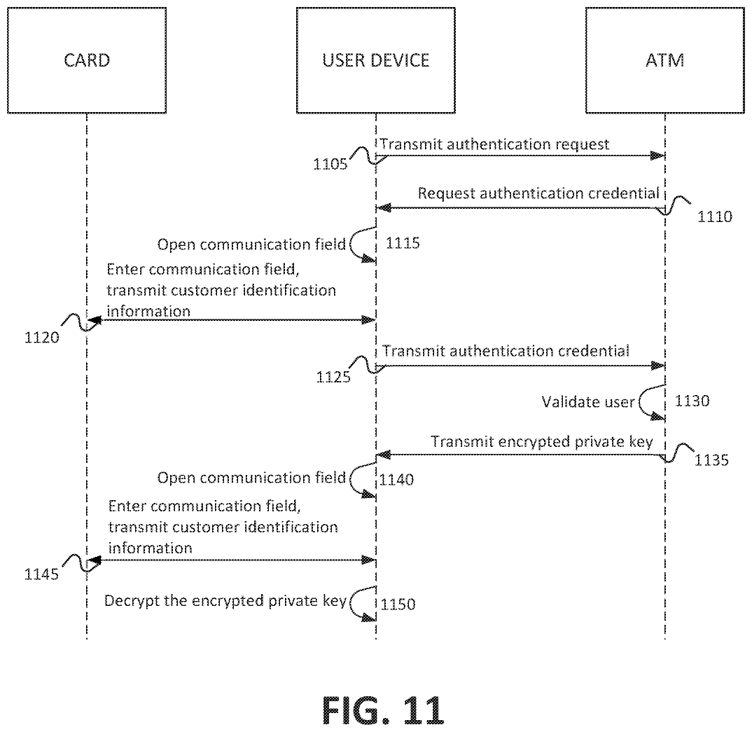

FIG. 11 is a sequence diagram illustrating a process of requesting a virtual copy of a private key according to an example embodiment.

The process can begin with step 1105 in which the user device transmits an authentication request to the ATM. This step can be performed by a processor associated with the user device.

Next, in step 1110 the ATM response to the authentication request by requesting the user device to supply an authentication credential. The request can be carried out by a processor associated with the ATM.

In step 1115 the user device opens a communication field. The communication field can be opened by a processor. The processor can be associated with the card or the user device.

Next, in step 1120 the card and the user device enter the communication field and exchange customer identification information. The information may be identity information or other secure information associated with the user. The information may be the applet information stored in the card's memory. The information shared by be encrypted using diversified key exchange further described with reference to FIG. 8. The credential can include without limitation a personal identification number (PIN), password, or card information. In other embodiments, the credential can be associated with a biometric transmitted from the user to the ATM. As a nonlimiting example, the user can supply a fingerprint scan, facial scan, or voice scan to the ATM.

In step 1125 the user device transmits the authentication credential to the ATM. The transmission can be performed by a processor. The processor may be a part of the user device.

Next, in step 1130 the ATM validates the user device. This step can be performed by a processor or a predetermined algorithm. This step may also be associated with a cryptographic decryption further explained with reference to FIG. 8.

Next, in step 1135 the ATM transmits the encrypted private key. This step can be performed by a processor associated with the ATM. The transmission can happen over a network.

Next, in step 1140 the user device opens a communication field. The communication field can be via NFC, Bluetooth, RFID, Wi-Fi, and/or the like. This step can be performed by a processor. The processor can be a part of the user device or the card

In step 1145, the card and the user device enter a communication field and share customer identification information. The information may be identity information or other secure information associated with the user. The information may be the applet information stored in the card's memory. The information shared by be encrypted using diversified key exchange further described with reference to FIG. 8.

Next, in step 1150 the user device decrypts the encrypted private key. This can be accomplished by a processor applying a predetermined decryption algorithm. The process of decryption is further explained with reference to FIG. 8.

In some aspects, the techniques described herein relate to a system for the storing and retrieving private keys associated with a cryptocurrency wallet, the system including: a card; a user device; and an automated teller machine (ATM) further including: a data storage unit; and a processor configured to: transmit an authentication request for a private key; receive an authentication credential associated with the private key; validate, by applying an algorithm, the authentication credential, the authentication credential associated with user identification data; and transmit the private key associated with a cryptocurrency wallet to the user.

In some aspects, the techniques described herein relate to a system, wherein the user device is a computer-enabled device including at least one selected from the group of a smart phone, computer, and a tablet.

In some aspects, the techniques described herein relate to a system, wherein the private key is transmitted to the user through at least one selected from the group of one or more pieces of paper, a flash drive, and a disk.

In some aspects, the techniques described herein relate to a system, wherein the processor is further configured to decrypt an encrypted private key.

In some aspects, the techniques described herein relate to a system, wherein the private key is 256-bit number represented by a seed phrase.

In some aspects, the techniques described herein relate to a system, wherein the private key is 256-bit number represented by characters chosen from the group of the integers 0 through 9 and the letters A through F.

In some aspects, the techniques described herein relate to a system, wherein the authentication request, authentication credential, and the private key can be shared through near field communication (NFC) between the card and the ATM.

In some aspects, the techniques described herein relate to a system, wherein the authentication request, authentication credential, and the private key can be shared through near field communication (NFC) between the user device and the ATM.

In some aspects, the techniques described herein relate to a method for storing and validating private keys associated with a cryptocurrency wallet, the method including the steps of: providing an ATM with a data storage unit further configured to hold an encrypted private key; transmitting, by a processor, an authentication request for the private key; opening, in response to the authentication request, a communication field between a user device and a card; receiving, by the processor, an authentication credential for the private key, the authentication credential associated with user identification data; validating, by the processor, the authentication credential; and transmitting the private key from the ATM to the user device.

In some aspects, the techniques described herein relate to a method, wherein the user device is a computer enabled device including at least from the group of a computer-enabled smart phone, computer, or tablet.

In some aspects, the techniques described herein relate to a method, wherein the private key is transmitted to the user through at least one from the group of one or more pieces of paper, a flashdrive, and a disk.

In some aspects, the techniques described herein relate to a method, wherein the private key is transmitted to the card or a computer-enabled device through near field communication (NFC) with the ATM.

In some aspects, the techniques described herein relate to a method, wherein the method further includes the steps of: providing, by the processor over a network, a private key to a data storage unit not associated with the ATM; receiving, by the processor, a request to retrieve the private key from the data storage unit; requesting, by the processor, an authentication credential from the user device; opening, in response to the authentication request, a communication field between the user device and a card; receiving, over a network, the authentication credential from the user device, the authentication credential associated with user identification data; validating, by a processor, the authentication credential; and transmitting, from the data storage unit over the network, the private key to the user device.

In some aspects, the techniques described herein relate to a method, wherein the data storage unit is associated with a banking or financial institution associated with the user.

In some aspects, the techniques described herein relate to a method, wherein the private key is stored and transmitted in an encrypted form within the data storage unit.

In some aspects, the techniques described herein relate to a method, wherein the authentication credential can be at least one selected from the group of a social security number associated with the user, banking or financial information associated with the user, or biometric information associated with the user.

In some aspects, the techniques described herein relate to a non-transitory computer-readable storage medium, the computer-readable storage medium including instructions that, when executed by a computer hardware arrangement including a processor, configure the processor to perform procedures including the steps of: transmitting an authentication request for a private key; opening, in response to the authentication request, a communication field between a user device and a card; receiving an authentication credential for the private key, the authentication credential associated with user identification data; validating the authentication credential; and transmitting the private key to the user device.

In some aspects, the techniques described herein relate to a computer-readable storage medium, wherein the procedures further include the steps of decrypting, by a predetermined algorithm, the encrypted private key.

In some aspects, the techniques described herein relate to a computer-readable storage medium, wherein the procedures further include generating multiple private keys suitable for a cryptocurrency wallet.

In some aspects, the techniques described herein relate to a computer-readable storage medium, wherein the processor is associated with at least one selected from the group of a mobile device, ATM, or a separate server.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

Throughout the disclosure, the term “bank” is used, and it is understood that the present disclosure is not limited to a particular bank or type of bank. Rather, the present disclosure includes any type of bank or other business involved in activities where products or services are sold or otherwise provided.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for the storing and retrieving private keys associated with a cryptocurrency wallet, the system comprising:
a card;
a user device; and
an automated teller machine (ATM) further comprising:
a data storage unit; and
a processor configured to:
transmit an authentication request for a private key;
receive an authentication credential associated with the private key;
validate, by applying an algorithm, the authentication credential, the authentication credential associated with user identification data; and
transmit the private key associated with the cryptocurrency wallet to the user.

2. The system of claim 1, wherein the user device is a computer-enabled device comprising at least one selected from the group of a smart phone, computer, and a tablet.

3. The system of claim 1, wherein the private key is transmitted to the user through at least one selected from the group of one or more pieces of paper, a flash drive, and a disk.

4. The system of claim 1, wherein the processor is further configured to decrypt an encrypted private key.

5. The system of claim 1, wherein the private key is 256-bit number represented by a seed phrase.

6. The system of claim 1, wherein the private key is 256-bit number represented by characters chosen from the group of the integers 0 through 9 and the letters A through F.

7. The system of claim 1, wherein the authentication request, authentication credential, and the private key can be shared through near field communication (NFC) between the card and the ATM.

8. The system of claim 1, wherein the authentication request, authentication credential, and the private key can be shared through near field communication (NFC) between the user device and the ATM.

9. A method for storing and validating private keys associated with a cryptocurrency wallet, the method comprising the steps of:
providing an ATM with a data storage unit further configured to hold an encrypted private key;
transmitting, by a processor, an authentication request for the private key;
opening, in response to the authentication request, a communication field between a user device and a card;
receiving, by the processor, an authentication credential for the private key, the authentication credential associated with user identification data;
validating, by the processor, the authentication credential; and
transmitting the private key from the ATM to the user device.

10. The method of claim 9, wherein the user device is a computer enabled device comprising at least from the group of a computer-enabled smart phone, computer, or tablet.

11. The method of claim 9, wherein the private key is transmitted to the user through at least one from the group of one or more pieces of paper, a flashdrive, and a disk.

12. The method of claim 9, wherein the private key is transmitted to the card or a computer-enabled device through near field communication (NFC) with the ATM.

13. The method of claim 9, wherein the method further comprises the steps of:
providing, by the processor over a network, a private key to a data storage unit not associated with the ATM;
receiving, by the processor, a request to retrieve the private key from the data storage unit;
requesting, by the processor, an authentication credential from the user device;
opening, in response to the authentication request, a communication field between the user device and a card;
receiving, over a network, the authentication credential from the user device, the authentication credential associated with user identification data;
validating, by a processor, the authentication credential; and
transmitting, from the data storage unit over the network, the private key to the user device.

14. The method of claim 13, wherein the data storage unit is associated with a banking or financial institution associated with the user.

15. The method of claim 13, wherein the private key is stored and transmitted in an encrypted form within the data storage unit.

16. The method of claim 13, wherein the authentication credential can be at least one selected from the group of a social security number associated with the user, banking or financial information associated with the user, or biometric information associated with the user.

17. A non-transitory computer-readable storage medium, the computer-readable storage medium including instructions that, when executed by a computer hardware arrangement comprising a processor, configure the processor to perform procedures comprising the steps of:
transmitting an authentication request for a private key;
opening, in response to the authentication request, a communication field between a user device and a card;
receiving an authentication credential for the private key, the authentication credential associated with user identification data;
validating the authentication credential; and
transmitting the private key to the user device.

18. The computer-readable storage medium of claim 17, wherein the procedures further comprise the steps of decrypting, by a predetermined algorithm, the encrypted private key.

19. The computer-readable storage medium of claim 17, wherein the procedures further comprise generating multiple private keys suitable for a cryptocurrency wallet.

20. The computer-readable storage medium of claim 17, wherein the processor is associated with at least one selected from the group of a mobile device, ATM, or a separate server.
